(19) United States
(12) Patent Application Publication
(10) Pub. No.: US 2020/0348749 A1
(43) Pub. Date: Nov. 5, 2020

(54) INFORMATION PROCESSING APPARATUS, INFORMATION PROCESSING METHOD, AND PROGRAM

(71) Applicant: SONY CORPORATION, TOKYO (JP)

(72) Inventors: RYO FUKAZAWA, KANAGAWA (JP); AKANE KONDO, TOKYO (JP); KEI NITTA, TOKYO (JP)

(21) Appl. No.: 16/960,403

(22) PCT Filed: Dec. 25, 2018
(86) PCT No.: PCT/JP2018/047616

§ 371 Date: Jul. 7, 2020

(30) Foreign Application Priority Data
Jan. 18, 2018 (JP) 2018-006525

(51) Int. Cl. G06F 3/01

(52) U.S. Cl. CPC G06F 3/011; G06F 3/017

(57) ABSTRACT

[Problem] To provide an information processing apparatus, an information processing method, and a program capable of improving usability.

[Solution] An information processing apparatus that includes an input method determination unit configured to determine an operation input method related to a virtual object that is arranged in a real space, on the basis of arrangement information on the virtual object.

### FIELD

The present disclosure relates to an information processing apparatus, an information processing method, and a program.

### BACKGROUND

In recent years, a head-mounted display (hereinafter, also referred to as an “HMD”) that includes a sensor has been developed. The HMD includes a display that is located in front of eyes of a user when the HMD is worn on a head of the user, and displays a virtual object in front of the user, for example. In the HMD as described above, the display may be of a transmissive type or a non-transmissive type. In an HMD including a transmissive-type display, the virtual object as described above is displayed, in a superimposed manner, on a real space that can be viewed via the display.

Operation input performed by a user on the HMD may be realized based on, for example, sensing performed by a sensor included in the HMD. For example, Patent Literature 1 described below discloses a technology in which a user who is wearing an HMD causes a camera (one example of the sensor) included in the HMD to sense various gestures using a user's hand, and operates the HMD by gesture recognition.

### CITATION LIST

Patent Literature

Patent Literature 1: JP 2014-186361 A

### SUMMARY

### Technical Problem

However, when the user performs operation input by using a virtual object arranged in a three-dimensional real space, in some cases, it may be difficult to perform operation input using a predetermined operation input method depending on a position of the virtual object, and usability may be reduced.

To cope with this situation, in the present disclosure, an information processing apparatus, an information processing method, and a program capable of improving usability by determining an operation input method based on arrangement of a virtual object are proposed.

### Solution to Problem

According to the present disclosure, an information processing apparatus is provided that includes: an input method determination unit configured to determine an operation input method related to a virtual object that is arranged in a real space, on the basis of arrangement information on the virtual object.

Moreover, according to the present disclosure, an information processing method is provided that includes: determining an operation input method related to a virtual object that is arranged in a real space, on the basis of arrangement information on the virtual object.

Moreover, according to the present disclosure, a program is provided that causes a computer to realize a function to execute: determining an operation input method related to a virtual object that is arranged in a real space, on the basis of arrangement information on the virtual object.

### Advantageous Effects of Invention

As described above, according to the present disclosure, it is possible to improve usability by switching between operation input methods based on arrangement of a virtual object.

In addition, the effects described above are not limiting. That is, any of the effects described in the present specification or other effects that may be recognized from the present specification may be achieved, in addition to or in place of the effects described above.

### BRIEF DESCRIPTION OF DRAWINGS

FIG. 1 is a diagram for explaining an overview of an information processing apparatus 1 according to a first embodiment of the present disclosure.

FIG. 2 is a block diagram illustrating a configuration example of the information processing apparatus 1 according to the first embodiment.

FIG. 3 is a flowchart illustrating an example of operation of the information processing apparatus 1 according to the first embodiment.

FIG. 4 is an explanatory diagram illustrating an exemplary case in which touch operation is determined as an operation input method according to the first embodiment.

FIG. 5 is an explanatory diagram illustrating an exemplary case in which pointing operation is determined as the operation input method according to the first embodiment.

FIG. 6 is an explanatory diagram illustrating an exemplary case in which command operation is determined as the operation input method according to the first embodiment.

FIG. 7 is an explanatory diagram for explaining an overview of a second embodiment of the present disclosure.

FIG. 8 is a block diagram illustrating a configuration example of an information processing apparatus 1-2 according to the second embodiment of the present disclosure.

FIG. 9 is a flowchart illustrating an example of operation of the information processing apparatus 1-2 according to the second embodiment.

FIG. 10 is an explanatory diagram for explaining a first arrangement control example according to the second embodiment.

FIG. 11 is an explanatory diagram for explaining a second arrangement control example according to the second embodiment.

FIG. 12 is an explanatory diagram for explaining the second arrangement control example according to the second embodiment.

FIG. 13 is an explanatory diagram for explaining a third arrangement control example according to the second embodiment.

FIG. 14 is an explanatory diagram for explaining the third arrangement control example according to the second embodiment according to the embodiment.

FIG. 15 is an explanatory diagram for explaining a fourth arrangement control example according to the second embodiment.

FIG. 16 is an explanatory diagram for explaining the fourth arrangement control example according to the second embodiment.

FIG. 17 is an explanatory diagram for explaining the fourth arrangement control example according to the second embodiment.

FIG. 18 is an explanatory diagram for explaining a modification of the second embodiment.

FIG. 19 is an explanatory diagram for explaining a modification of the second embodiment.

FIG. 20 is an explanatory diagram for explaining a modification of the second embodiment.

FIG. 21 is an explanatory diagram for explaining a modification of the second embodiment.

FIG. 22 is an explanatory diagram illustrating a hardware configuration example.

### DESCRIPTION OF EMBODIMENTS

Preferred embodiments of the present disclosure will be described in detail below with reference to the accompanying drawings. In this specification and the drawings, structural elements that have substantially the same functions and configurations will be denoted by the same reference symbols, and repeated explanation of the structural elements will be omitted.

Furthermore, in this specification and the drawings, a plurality of structural elements that have substantially the same or similar functions and configurations may be distinguished from one another by appending different alphabets after the same reference symbols. However, if the structural elements that have substantially the same or similar functions and configurations need not be specifically distinguished from one another, the structural elements will be denoted by only the same reference symbols.

In addition, hereinafter, explanation will be given in the following order.

<<1. First embodiment>>

<1-1. Overview>

<1-2. Configuration>

<1-3. Operation>

<1-4. Examples of operation input method>

<1-5. Modifications>

<1-6. Effects>

<<2. Second embodiment>>

<2-1. Overview>

<2-2. Configuration>

<2-3. Operation>

<2-4. Examples of arrangement control>

<2-5. Modification>

<2-6. Effects>

<<3. Hardware configuration example>>

<<4. Conclusion>>

### 1. First Embodiment

<1-1. Overview>

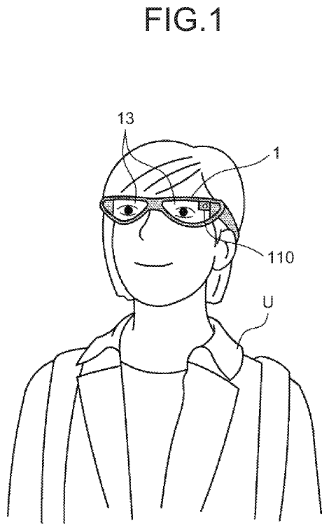

First, an overview of an information processing apparatus according to a first embodiment of the present disclosure will be described. FIG. 1 is a diagram for explaining an overview of an information processing apparatus 1 according to the first embodiment. As illustrated in FIG. 1, the information processing apparatus 1 according to the first embodiment is realized by, for example, a glasses-type head-mounted display (HMD) that is worn on a head of a user U. A display unit 13 that corresponds to an eyeglass lens part located in front of eyes of the user U when the HMD is worn may be a transmissive type or a non-transmissive type. The information processing apparatus 1 is able to provide a display object in front of a line of sight of the user U by displays the display object on the display unit 13. Further, an HMD as one example of the information processing apparatus 1 is not limited to a device that provides videos for both eyes, but may be a device that provides a video for only one eye. For example, the HMD may be a one eye type provided with the display unit 13 that displays a video for only one eye.

Further, the information processing apparatus 1 includes an out-camera 110 that captures images in a line-of-sight direction of the user U, that is, in an outward direction, when the apparatus is worn. Furthermore, while not illustrated in FIG. 1, the information processing apparatus 1 includes various sensors, such as an in-camera that captures images of the eyes of the user U when the apparatus is worn, or a microphone (hereinafter, referred to as a “mic”). It may be possible to provide the plurality of out-cameras 110 and the plurality of in-cameras. If the plurality of out-cameras 110 are provided, it is possible to obtain a depth image (distance image) using disparity information, so that it is possible to three-dimensionally sense surrounding environments.

Meanwhile, the shape of the information processing apparatus 1 is not limited to the example as illustrated in FIG. 1. For example, the information processing apparatus 1 may be a headband type HMD (a type that is worn by a band extended around the entire circumference of the head or a type including a band that is extended along not only the side of the head, but also the top of the head), or a helmet type HMD (a visor part of a helmet serves as a display). Further, the information processing apparatus 1 may be realized by a wearable device of a wrist band type (for example, a smart watch with or without a display), a headphone type (without a display), a neck phone type (a neck holder type with or without a display), or the like.

Furthermore, the information processing apparatus 1 according to the first embodiment is realized by the wearable device as described above and can be worn on the user U; therefore, the information processing apparatus 1 may include various operation input methods, such as voice input, gesture input using a hand or a head, and a line of sight input, in addition to using a button, a switch, or the like.

Moreover, the display unit 13 may display a virtual object related to operation input. For example, the user U may be allowed to perform touch operation of touching the virtual object, pointing operation of pointing the virtual object by an operation object, such as a finger, or voice command operation by speaking a voice command indicated by the virtual object.

Furthermore, for example, if the display unit 13 is a transmissive type, the information processing apparatus 1 is able to arrange a virtual object in a real space on the basis of information on the real space obtained by capturing performed by the camera 110, and displays the virtual object such that the user U can view the virtual object as if the virtual object is located in the real space.

Meanwhile, if an apparatus includes various operation input methods like the information processing apparatus 1, it is often the case that an operation input method that is determined in advance by, for example, an application or the like is adopted with respect to a virtual object to be displayed. However, if the virtual object is arranged in the real space as described above, in some cases, depending on a position of the virtual object, it may be difficult to perform operation input by using the operation input method determined in advance and usability may be reduced. In particular, if the user is allowed to freely change arrangement of the virtual object, it is likely that the virtual object may be arranged at a position at which the operation input method determined in advance is not appropriate.

To cope with this, the information processing apparatus 1 according to the first embodiment determines an operation input method based on arrangement of a virtual object, to thereby improve usability. A configuration of the first embodiment that achieves the above-described effects will be described in detail below.

<1-2. Configuration>

The overview of the information processing apparatus 1 according to the first embodiment has been described above.

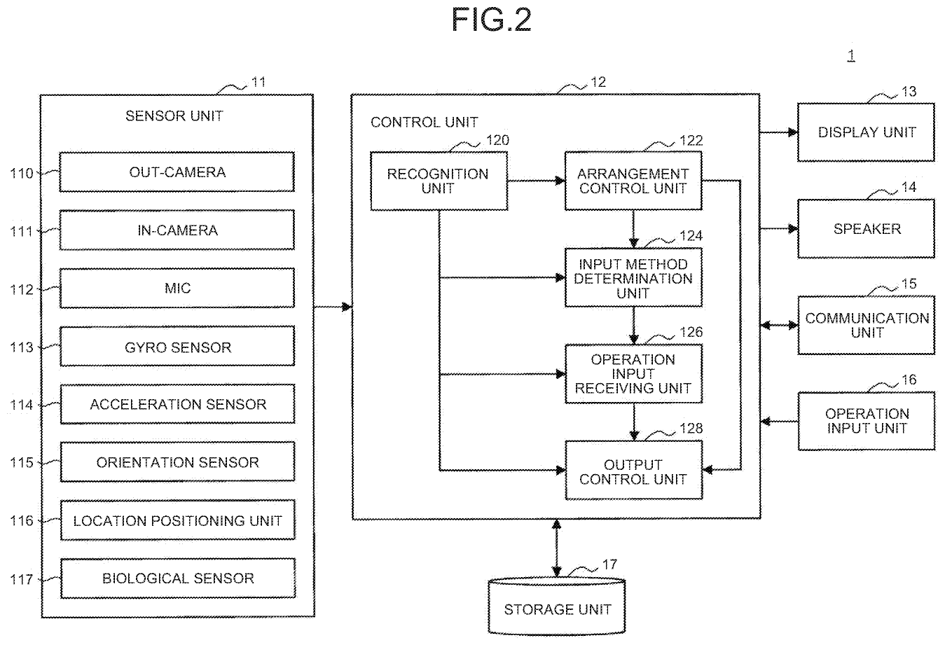

Next, a configuration of the information processing apparatus 1 according to the first embodiment will be described with reference to FIG. 2. FIG. 2 is a block diagram illustrating a configuration example of the information processing apparatus 1 according to the first embodiment. As illustrated in FIG. 2, the information processing apparatus 1 includes a sensor unit 11, a control unit 12, the display unit 13, a speaker 14, a communication unit 15, an operation input unit 16, and a storage unit 17.

(Sensor Unit 11)

The sensor unit 11 has a function to acquire various kinds of information on a user or surrounding environments. For example, the sensor unit 11 includes an out-camera 110, an in-camera 111, a mic 112, a gyro sensor 113, an acceleration sensor 114, an orientation sensor 115, a location positioning unit 116, and a biological sensor 117. A specific example of the sensor unit 11 described herein is one example, and embodiments are not limited to this example. Further, the number of each of the sensors may be two or more.

Each of the out-camera 110 and the in-camera 111 includes a lens system that includes an imaging lens, a diaphragm, a zoom lens, a focus lens, and the like, a driving system that causes the lens system to perform focus operation and zoom operation, a solid-state imaging element array that generates an imaging signal by performing photoelectric conversion on imaging light obtained by the lens system, and the like. The solid-state imaging element array may be realized by, for example, a charge coupled device (CCD) sensor array or a complementary metal oxide semiconductor (CMOS) sensor array.

The mic 112 collects voice of a user and sounds in surrounding environments, and outputs them as voice data to the control unit 12.

The gyro sensor 113 is realized by, for example, a three-axis gyro sensor, and detects an angular velocity (rotational speed).

The acceleration sensor 114 is realized by, for example, a three-axis acceleration sensor (also referred to as a G sensor), and detects acceleration at the time of movement.

The orientation sensor 115 is realized by, for example, a three-axis geomagnetic sensor (compass), and detects an absolute direction (orientation).

The location positioning unit 116 has a function to detect a current location of the information processing apparatus 1 on the basis of a signal acquired from outside. Specifically, for example, the location positioning unit 116 is realized by a global positioning system (GPS) measurement unit, receives radio waves from GPS satellites, detects a position at which the information processing apparatus 1 is located, and outputs the detected location information to the control unit 12. Further, for example, the location positioning unit 116 may be a device that detects a position through Wi-Fi (registered trademark), Bluetooth (registered trademark), transmission/reception with a mobile phone, a PHS, a smartphone, etc., near field communication, or the like, instead of the GPS.

The biological sensor 117 detects biological information on a user. Specifically, for example, the biological sensor 117 may detect heartbeats, body temperature, diaphoresis, blood pressure, pulse, breathing, eye blink, eye movement, a gaze time, a size of a pupil diameter, blood pressure, brain waves, body motion, body position, skin temperature, electric skin resistance, MV (micro-vibration), myopotential, SPO2 (blood oxygen saturation level) or the like.

(Control Unit 12)

The control unit 12 functions as an arithmetic processing device and a control device, and controls entire operation in the information processing apparatus 1 in accordance with various programs. Further, as illustrated in FIG. 2, the control unit 12 according to the first embodiment functions as a recognition unit 120, an arrangement control unit 122, an input method determination unit 124, an operation input receiving unit 126, and an output control unit 128.

The recognition unit 120 has a function to perform recognition on a user or recognition on surrounding conditions by using various kinds of sensor information sensed by the sensor unit 11. For example, the recognition unit 120 may recognize a position and a posture of the head of the user (including orientation or inclination of the face with respect to the body), positions and postures of arms, hands and fingers of the user, a user's line of sight, user's voice, user's behavior, or the like. Further, the recognition unit 120 may recognize a three-dimensional position or shape of a real object (including the ground, floors, walls, and the like) that is present in a surrounding real space. The recognition unit 120 provides a recognition result on the user and a recognition result on the surrounding conditions to the arrangement control unit 122, the input method determination unit 124, the operation input receiving unit 126, and the output control unit 128.

The arrangement control unit 122 controls arrangement of a virtual object that is arranged in a real space, and provides arrangement information on the arrangement of the virtual object to the input method determination unit 124 and the output control unit 128.

For example, the arrangement control unit 122 may control the arrangement of the virtual object in the real space on the basis of a setting for the arrangement of the virtual object, where the setting is determined in advance. It may be possible to determine, in advance, a setting for arranging the virtual object such that the virtual object comes into contact with a real object around the user, a setting for arranging the virtual object in the air in front of the user, or the like.

Further, it may be possible to determine, in advance, a plurality of settings with priorities, and the arrangement control unit 122 may determine whether arrangement is possible in each of the settings in order from the highest to the lowest priorities, and may control the arrangement of the virtual object based on the setting for which it is determined that the arrangement is possible. Meanwhile, the arrangement control unit 122 may acquire the setting for the arrangement of the virtual object from, for example, the storage unit 17 or from other devices via the communication unit 15.

Furthermore, the arrangement control on the virtual object performed by the arrangement control unit 122 according to the first embodiment is not limited to the example as described above. Other examples of the arrangement control performed by the arrangement control unit 122 will be described later as modifications.

The input method determination unit 124 determines an operation input method related to the virtual object on the basis of the arrangement information provided from the arrangement control unit 122. The input method determination unit 124 may determine the operation input method on the basis of the recognition result on the user or the recognition result on the surrounding environments, where the recognition result is provided from the recognition unit 120.

For example, the input method determination unit 124 may determine whether the user is able to touch the virtual object (whether the virtual object is arranged in a range in which the user is able to virtually touch the object) on the basis of the recognition result on the user, and determine the operation input method on the basis of the previous determination. The determination on whether the user is able to touch the virtual object may be performed based on a recognition result of the hands of the user or based on a distance between a head position of the user and the virtual object.

Furthermore, if the user is able to touch the virtual object, the input method determination unit 124 may determine touch operation as the operation input method. Meanwhile, the touch operation in this specification is operation of virtually contacting (touching) the virtual object by a finger, a hand, or the like, for example.

With this configuration, if the virtual object is arranged in the range in which the user is able to directly touch the virtual object, the touch operation that allows more direct operation is determined as the operation input method, so that the usability can be improved.

Moreover, the input method determination unit 124 may determine whether a real object present in a real space and the virtual object are in contact with each other on the basis of the recognition result on the surrounding environments, and determine the operation input method on the basis of the previous determination. The determination on whether the real object and the virtual object are in contact with each other may be performed based on a recognition result of a position or a shape of the surrounding real object and the arrangement information on the virtual object.

Furthermore, if the real object present in the real space and the virtual object are in contact with each other, the input method determination unit 124 may determine pointing operation as the operation input method. Meanwhile, the pointing operation in this specification is the operation input method of pointing the virtual object by an operation object, such as a finger or a hand, for example. The operation object may be a finger of the user, a hand of the user, or a real object held by the user. Moreover, pointing may be performed using a user's line of sight. The input method determination unit 124 may determine both of the pointing operation using the operation object and the pointing operation using the line of sight as the operation input methods, or may determine one of them as the operation input method.

If the virtual object is in contact with the real object, the user can easily focus on the virtual object and recognize a position of the virtual object or a distance to the virtual object, so that the user is able to perform the pointing operation more easily.

Furthermore, if the real object present in the real space and the virtual object are not in contact with each other (the virtual object is arranged in the air), the input method determination unit 124 may determine voice command operation or command operation performed by the operation input unit 16 (to be described later) as the operation input method. It is difficult to recognize a sense of distance in the touch operation and the pointing operation on the virtual object arranged in the air. Moreover, extension of a hand into the air where a real object is absent may cause fatigue in the user. In contrast, the voice command operation or the command operation by the operation input unit 16 is effective in that a physical load on the user is small.

Meanwhile, the determination of the operation input method as described above may be performed in a combined manner. For example, if the virtual object is in contact with the real object and if the user is able to touch the virtual object, the input method determination unit 124 may determine the touch operation as the operation input method. With this configuration, the user is able to perform operation input by directly touching the real object, so that tactile feedback to a hand or a finger of the user is virtually performed and usability can further be improved.

The operation input receiving unit 126 receives operation input performed by the user, and outputs operation input information to the output control unit 128. The operation input receiving unit 126 according to the first embodiment may receive operation input performed by the operation input method determined by the input method determination unit 124, or the operation input receiving unit 126 may receive operation input performed by the user with respect to the virtual object by using information corresponding to the operation input method determined by the input method determination unit 124. In other words, the information that is used by the operation input receiving unit 126 to receive the operation input performed by the user may be different depending on the operation input method determined by the input method determination unit 124.

For example, if the input method determination unit 124 determines the touch operation or the pointing operation using the operation object as the operation input method, the operation input receiving unit 126 uses captured image information obtained by the out-camera 110. Further, if the input method determination unit 124 determines the pointing operation using the line of sight as the operation input method, the operation input receiving unit 126 uses gyro sensor information, acceleration information, orientation information, and captured image information obtained by the in-camera 111. Furthermore, if the input method determination unit 124 determines the voice command operation as the operation input method, the operation input receiving unit 126 uses voice data obtained by the mic 112. Moreover, if the input method determination unit 124 determines the command operation using the operation input unit 16 as the operation input method, the operation input receiving unit 126 uses information provided by the operation input unit 16.

The output control unit 128 controls display performed by the display unit 13 and voice output performed by the speaker 14, which will be described later. The output control unit 128 according to the first embodiment causes the display unit 13 to display the virtual object in accordance with the arrangement information on the virtual object provided by the arrangement control unit 122.

(Display Unit 13)

The display unit 13 is realized by, for example, a lens unit (one example of a transmissive display unit) that performs display using a holographic optical technology, a liquid crystal display (LCD) device, an organic light emitting diode (OLED) device, or the like. Further, the display unit 13 may be of a transmissive type, a semi-transmissive type, or a non-transmissive type.

(Speaker 14)

The speaker 14 reproduces a voice signal under the control of the control unit 12.

(Communication Unit 15)

The communication unit 15 is a communication module for performing data transmission and reception to and from other devices in a wired or wireless manner. The communication unit 15 performs wireless communication with external devices in a direct manner or via a wireless network access point by using a system, such as a wired local area network (LAN), a wireless LAN,

Wireless Fidelity (WI-Fi: registered trademark), infrared communication, Bluetooth (registered trademark), or near-field/contactless communication.

(Storage Unit 17)

The storage unit 17 stores therein programs and parameters for causing the control unit 12 as described above to implement each of the functions. For example, the storage unit 17 stores therein a three-dimensional shape of a virtual object, a setting for arrangement of the virtual object determined in advance, or the like.

Thus, the configuration of the information processing apparatus 1 according to the first embodiment has been described in detail above, but the configuration of the information processing apparatus 1 according to the first embodiment is not limited to the example illustrated in FIG. 2. For example, at least a part of the functions of the control unit 12 of the information processing apparatus 1 may be included in other devices connected via the communication unit 15.

(Operation Input Unit 16)

The operation input unit 16 is realized by an operation member having a physical structure, such as a switch, a button, or a lever.

<1-3. Operation>

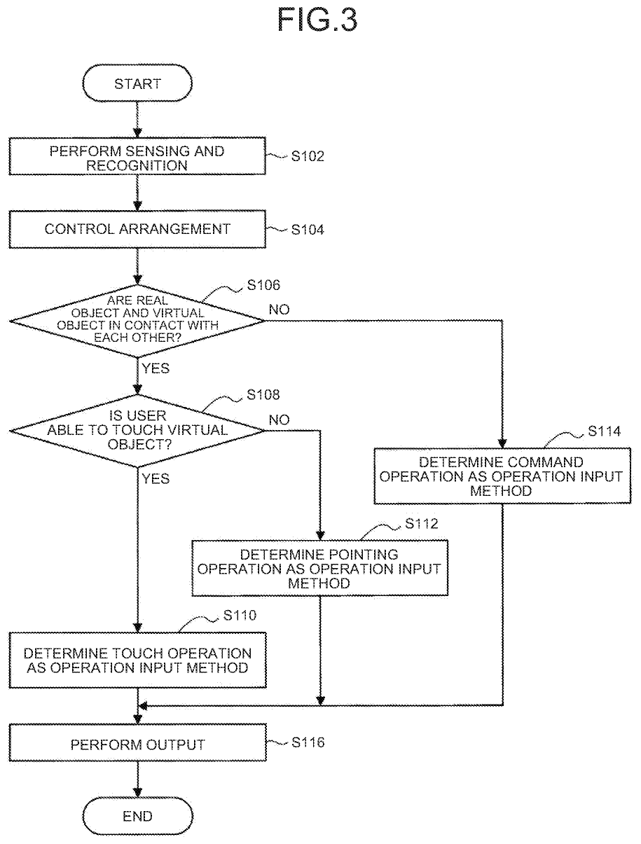

The configuration example of the information processing apparatus 1 according to the first embodiment has been described above. Next, operation of the information processing apparatus 1 according to the first embodiment will be described with reference to FIG. 3. FIG. 3 is a flowchart illustrating an example of the operation performed by the information processing apparatus 1 according to the first embodiment.

First, the sensor unit 11 performs sensing, and the recognition unit 120 performs recognition on the user and recognition on the surrounding conditions by using various kinds of sensor information obtained by the sensing (S102). Subsequently, the arrangement control unit 122 controls arrangement of a virtual object (S104). Further, the input method determination unit 124 determines whether a real object present in a real space and the virtual object are in contact with each other (S106).

If it is determined that the real object present in the real space and the virtual object are in contact with each other (Yes at S106), the input method determination unit 124 determines whether the user is able to touch the virtual object (S108). If it is determined that the user is able to touch the virtual object (Yes at S108), the input method determination unit 124 determines the touch operation as the operation input method (5110). In contrast, if it is determined that the user is not able to touch the virtual object (No at S108), the input method determination unit 124 determines the pointing operation as the operation input method (S112).

In contrast, if it is determined that the real object present in the real space and the virtual object are not in contact with each other (No at S106), the input method determination unit 124 determines the command operation as the operation input method (S114).

Finally, the output control unit 128 causes the display unit 13 to display (output) the virtual object in accordance with the arrangement control on the virtual object performed by the arrangement control unit 122 (S116). Meanwhile, the processes at Step S102 to 5116 as described above may be repeated sequentially.

<1-4. Examples of Operation Input Method>

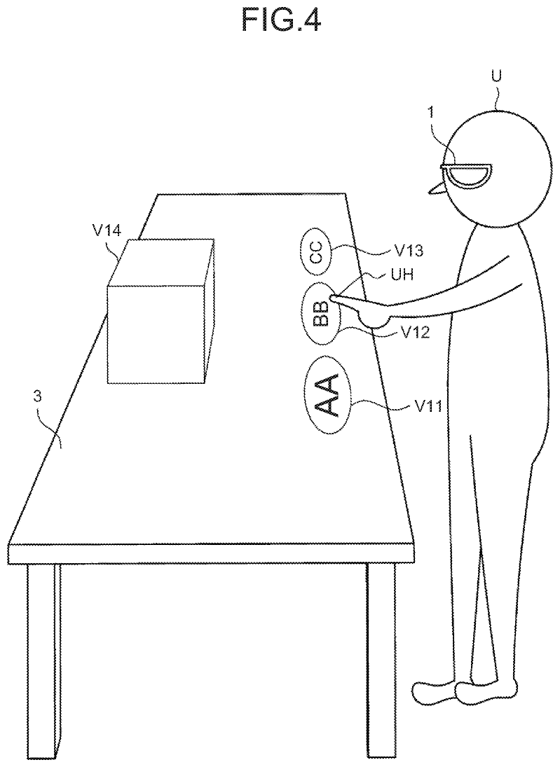

Examples of the operation input method according to the first embodiment will be described in detail below with reference to FIG. 4 to FIG. 6. In FIG. 4 to FIG. 6, the user U is wearing the information processing apparatus 1 that is a glasses-type HMD as illustrated in FIG. 1. Further, the display unit 13 of the information processing apparatus 1 located in front of the eyes of the user U is a transmissive type, and virtual objects V11 to V14 displayed on the display unit 13 are viewed by the user U as if the virtual objects V11 to V14 are present in a real space.

(Touch Operation)

FIG. 4 is an explanatory diagram illustrating an exemplary case in which the touch operation is determined as the operation input method. In the example illustrated in FIG. 4, the virtual objects V11 to V14 are arranged so as to come into contact with a table 3 (one example of the real object) in front of the user U, and the user U is able to touch the virtual objects. Therefore, the input method determination unit 124 determines the touch operation as the operation input method. In the example illustrated in FIG. 4, the user U performs operation input by touching the virtual object V12 by using a finger UH.

(Pointing Operation)

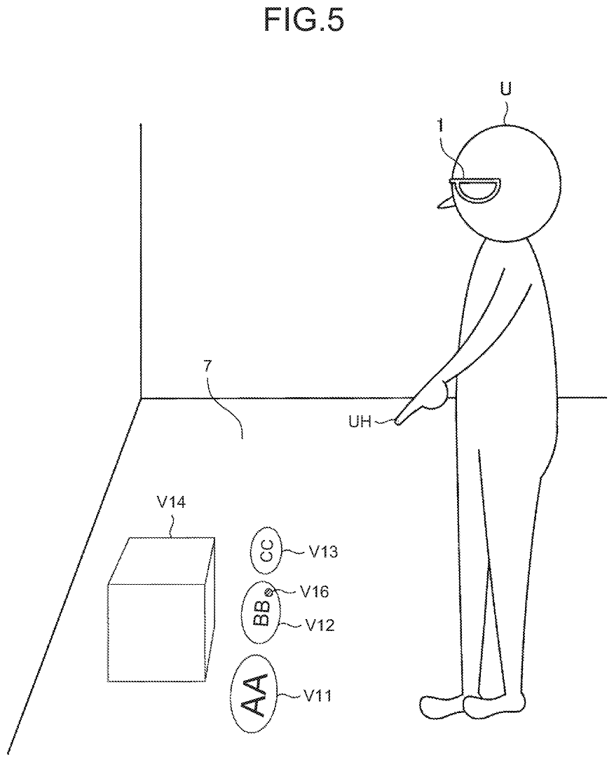

FIG. 5 is an explanatory diagram illustrating an exemplary case in which the pointing operation is determined as the operation input method. In the example illustrated in FIG. 5, the virtual objects V11 to V14 are arranged so as to come into contact with a floor 7 (one example of the real object) that is not reachable for the user U (the user U is not able to touch). Therefore, the input method determination unit 124 determines the pointing operation as the operation input method. In the example illustrated in FIG. 5, the user U performs operation input by pointing the virtual object V12 by using the finger UH. Meanwhile, if the pointing operation is determined as the operation input method, the output control unit 128 may display, on the display unit 13, a pointer V16 indicating a position pointed by the finger UH of the user U as illustrated in FIG. 5.

(Command Operation)

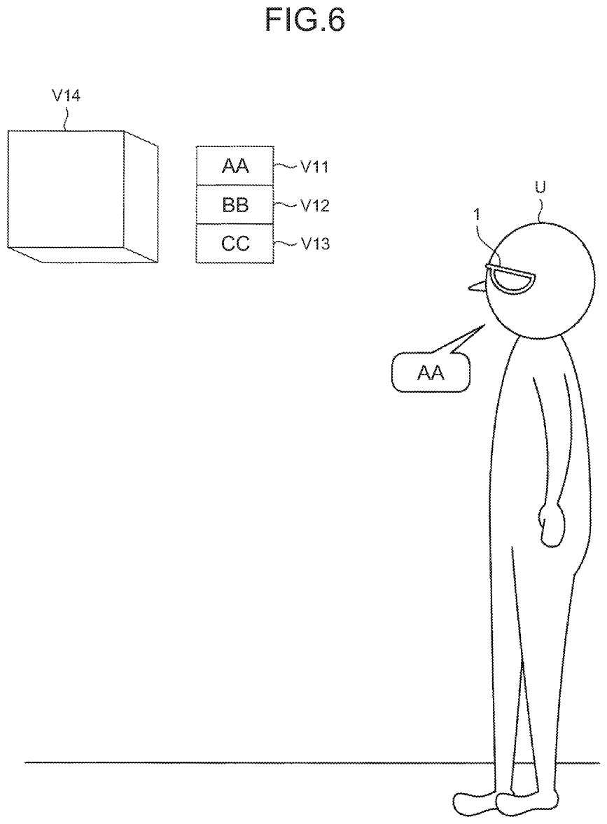

FIG. 6 is an explanatory diagram illustrating an exemplary case in which the command operation is determined as the operation input method. In the example illustrated in FIG. 6, the virtual objects V11 to V14 are arranged in the air. Therefore, the input method determination unit 124 determines the command operation as the operation input method. In the example illustrated in FIG. 6, the user U performs operation input by speaking a voice command “AA” indicated by the virtual object V11.

<1-5. Modifications>

The first embodiment of the present disclosure has been described above. In the following, some modifications of the first embodiment will be described. Meanwhile, the modifications described below may independently be applied to the first embodiment, or may be applied to the first embodiment in a combined manner. Further, each of the modifications may be applied in place of the configurations described in the first embodiment, or may be applied in addition to the configurations described in the first embodiment.

(Modification 1-1)

If a plurality of virtual objects are present, the input method determination unit 124 may determine the operation input method in accordance with a density of the virtual objects. For example, if the density of the virtual objects is high and the objects are arranged densely, it is likely that operation that is not intended by a user may be performed through the touch operation and the pointing operation; therefore, the input method determination unit 124 may determine the command operation as the operation input method. In contrast, if the density of the virtual objects is low, the input method determination unit 124 may determine the touch operation or the pointing operation as the operation input method.

(Modification 1-2)

The input method determination unit 124 may determine whether a moving body, such as a person, is present in a surrounding area on the basis of the recognition result on the surrounding conditions obtained by the recognition unit 120, and determine the operation input method on the basis of the previous determination. If the moving body is present around the user, it is likely that the user's line of sight may follow the moving body or the pointing operation may be disturbed due to blocking by the moving body or the like; therefore, the input method determination unit 124 may determine the command operation as the operation input method.

(Modification 1-3)

Further, the example in which the arrangement control unit 122 controls the arrangement of the virtual object in the real space on the basis of the setting for the arrangement of the virtual object determined in advance has been described above, but embodiments are not limited to this example.

The arrangement control unit 122 may control the arrangement of the virtual object in the real space on the basis of the operation input method determined by the input method determination unit 124.

For example, the arrangement control unit 122 may control an interval between virtual objects in accordance with the operation input method. For example, the touch operation allows operation input to be performed with higher accuracy than in the pointing operation, and therefore, if the touch operation is determined as the operation input method, the interval between the virtual objects may be reduced as compared to a case in which the pointing operation is determined as the operation input method. Further, the command operation is less likely to be influenced by the interval between the virtual objects; therefore, if the command operation is determined as the operation input method, it may be possible to further reduce the interval between the virtual objects, and, for example, the virtual objects may come into contact with each other.

Furthermore, the arrangement control unit 122 may control an arrangement direction of virtual objects in accordance with the operation input method. For example, if the virtual objects are arranged in a vertical direction with respect to a user, it may be difficult to perform the touch operation and the pointing operation. Therefore, if the touch operation or the pointing operation is determined as the operation input method, the arrangement control unit 122 may control arrangement such that the virtual objects are arranged in a horizontal direction with respect to the user. Moreover, the command operation is less likely to be influenced by the arrangement direction of the virtual objects; therefore, if the command operation is determined as the operation input method, the virtual objects may be arranged in the vertical direction or may be arranged in the horizontal direction. For example, if the command operation is determined as the operation input method, the arrangement control unit 122 may select, as the arrangement direction, a direction in which the virtual objects can be displayed in a more compact manner.

Furthermore, the arrangement control unit 122 may control arrangement of the virtual objects in the real space on the basis of a distance between the virtual objects and the user. For example, if the pointing operation is determined as the operation input method, pointing accuracy may be reduced with an increase in the distance between the virtual objects and the user. Therefore, if the pointing operation is determined as the operation input method, the arrangement control unit 122 may control the arrangement of the virtual objects such that the interval between the virtual objects increases with an increase in the distance between the virtual objects and the user. With this configuration, even if the distance between the virtual objects and the user is large, the user is able to easily perform the pointing operation, so that usability can further be improved.

Moreover, the arrangement control unit 122 may control the arrangement of the virtual objects in the real space on the basis of operation input performed by the user. For example, the user may be allowed to freely move one or a plurality of virtual objects. With this configuration, the user is able to freely arrange the virtual objects.

<1-6. Effects>

Thus, the first embodiment of the present disclosure has been described above. According to the first embodiment, it is possible to improve usability by determining the operation input method on the basis of arrangement of virtual objects.

### 2. Second Embodiment

<2-1. Overview>

A second embodiment of the present disclosure will be described below. Meanwhile, a part of the second embodiment is the same as the first embodiment, and therefore, explanation will be appropriately omitted. In the following, the same structural elements as those of the structural elements described in the first embodiment are denoted by the same reference symbols, and explanation of the structural elements will be omitted.

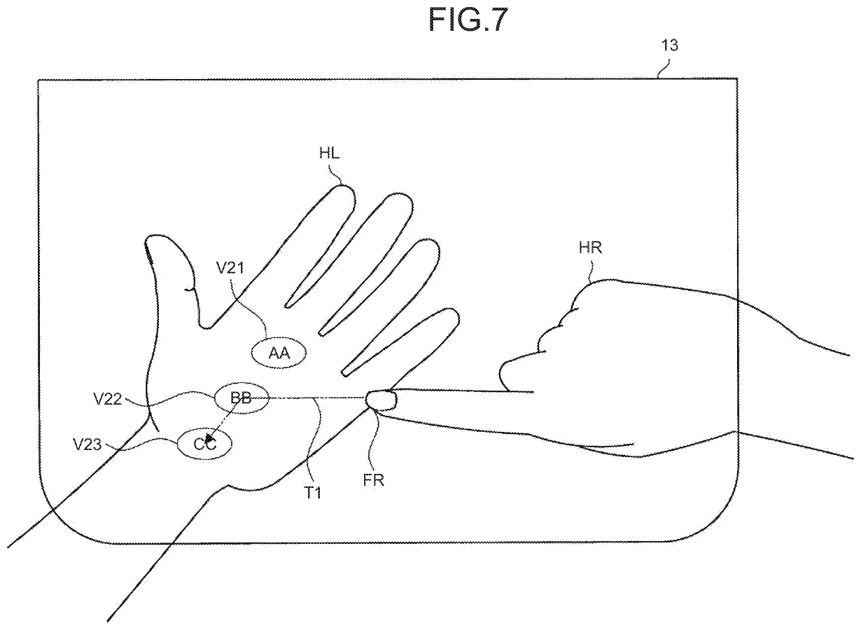

In the second embodiment of the present disclosure, a virtual object is arranged based on a display object (for example, a hand of a user). FIG. 7 is an explanatory diagram for explaining an overview of the second embodiment. In the example illustrated in FIG. 7, a left hand HL of the user is used as the display object, and virtual objects V21 to V23 are displayed on the display unit 13 as if the virtual objects V21 to V23 are arranged on the left hand HL (in such a manner that the virtual objects V21 to V23 are viewed by the user). Meanwhile, in the second embodiment, the display unit 13 may be a transmissive type.

Further, in the example illustrated in FIG. 7, the user is able to perform touch operation by using a finger FR of a right hand HR as the operation object. With this configuration, the user is able to perform the touch operation by using the left hand HL as a touch screen.

Here, for example, if the user moves the finger FR along a movement trajectory T1 as illustrated in FIG. 7 in order to perform operation input of selecting the virtual object V23, both of the virtual object V22 and the virtual object V23 may be recognized as being contacted (touched) by the finger FR. In other words, operation input of selecting the virtual object V22, which is not originally intended by the user, may be performed.

Therefore, in the second embodiment as described below, operation input that is not intended by the user is prevented by controlling arrangement of virtual objects on the basis of information on recognition of the operation object or recognition of the display object. A configuration of the second embodiment that achieves the above-described effects will be described in detail below.

<2-2. Configuration>

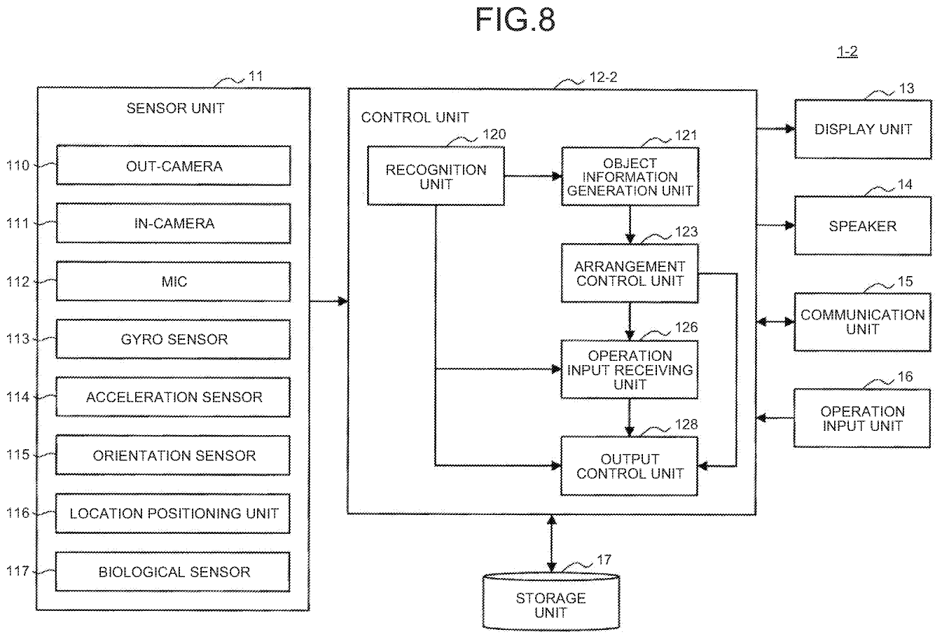

FIG. 8 is a block diagram illustrating a configuration example of an information processing apparatus 1-2 according to the second embodiment of the present disclosure. In the configuration illustrated in FIG. 8, constituent elements denoted by the same reference symbols as those of the constituent elements illustrated in FIG. 2 have the same configurations as those illustrated in FIG. 2, and therefore, explanation of the constituent elements will be omitted. As illustrated in FIG. 8, the information processing apparatus 1-2 according to the second embodiment is different from the information processing apparatus 1 according to the first embodiment in that functions of a control unit 12-2 are partially different from those of the control unit 12 illustrated in FIG. 2.

The control unit 12-2 functions as an arithmetic processing device and a control device, and controls entire operation in the information processing apparatus 1-2 in accordance with various programs, similarly to the control unit 12 according to the first embodiment. Further, as illustrated in FIG. 8, the control unit 12-2 according to the second embodiment functions as the recognition unit 120, an object information generation unit 121, an arrangement control unit 123, the operation input receiving unit 126, and the output control unit 128. In other words, the control unit 12-2 is different from the control unit 12 illustrated in FIG. 2 in that the control unit 12-2 functions as the object information generation unit 121 and the arrangement control unit 123, but does not function as the input method determination unit. In the following, the functions of the control unit 12-2 as the object information generation unit 121 and the arrangement control unit 123 will be described.

The object information generation unit 121 generates operation object information on the operation object used for operation input and display object information on the display object used to display a virtual object, on the basis of a recognition result obtained by the recognition unit 120.

In the second embodiment, the operation object is a finger of one hand of the user, and the display object is the other hand of the user. Meanwhile, the operation object and the display object are not limited to this example, and various real objects may be used for operation input or display.

The object information generation unit 121 may generate the operation object information and the display object information by assuming that one of the hands of the user recognized by the recognition unit 120 as the operation object and the other one of the hands as the display object. For example, it may be possible to determine a predetermined type of hand (a right hand or a left hand) as the operation object, and determine the other hand as the display object. Alternatively, it may be possible to determine a more opened hand as the display object in accordance with conditions of the hands.

The object information generation unit 121 may generate the operation object information including, for example, movement information on movement of the operation object. The movement information on the operation object may be information on a past movement history of the operation object, or information on a future movement trajectory that is predicted based on the movement history.

Further, the object information generation unit 121 may generate the display object information including information on a type of the display object. In the second embodiment, the information on the type of the display object may be, for example, information indicating whether the display object is the left hand or the right hand.

Furthermore, the object information generation unit 121 may generate the display object information including information on an angle of the display object. In the second embodiment, the information on the angle of the display object may be, for example, information indicating an angle of the display object with respect to a head posture of the user.

Moreover, the object information generation unit 121 may generate the display object information including information on a state of the display object. In the second embodiment, the information on the condition of the display object may be, for example, information indicating whether the hand serving as the display object is opened or closed, or information indicating whether the hand serving as the display object faces inward or outward.

The arrangement control unit 123, similarly to the arrangement control unit 122 according to the first embodiment, controls arrangement of a virtual object that is arranged in a real space, and provides arrangement information on the arrangement of the virtual object to the input method determination unit 124 and the output control unit 128. Further, the arrangement control unit 123, similarly to the arrangement control unit 122 according to the first embodiment, may control the arrangement of the virtual object in the real space on the basis of a setting for the arrangement of the virtual object, where the setting is determined in advance.

However, the arrangement control unit 123 according to the second embodiment is different from the arrangement control unit 122 according to the first embodiment in that the arrangement control unit 123 controls the arrangement of the virtual object on the basis of the operation object information or the display object information generated by the object information generation unit 121. For example, the arrangement control unit 123 according to the first embodiment may first arrange the virtual object in the real space on the basis of the setting for the arrangement of the virtual object determined in advance, and thereafter may change the arrangement of the virtual object on the basis of the operation object information or the display object information.

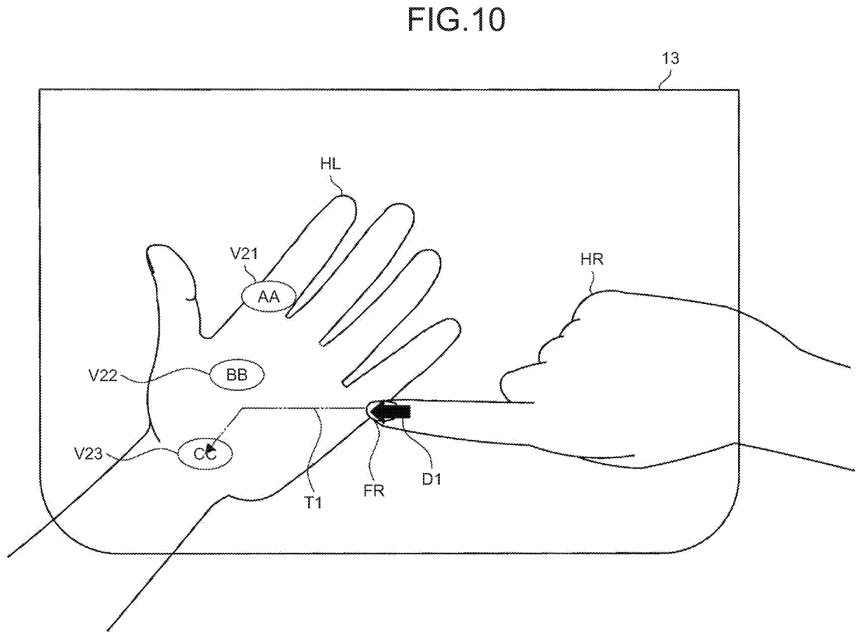

Meanwhile, specific examples of arrangement control performed by the arrangement control unit 123 will be described later with reference to FIG. 10 to FIG. 17.

As illustrated in FIG. 8, the control unit 12-2 according to the second embodiment does not have the function as the input method determination unit. In the second embodiment, the touch operation may be fixedly determined as the operation input method may, for example.

<2-3. Operation>

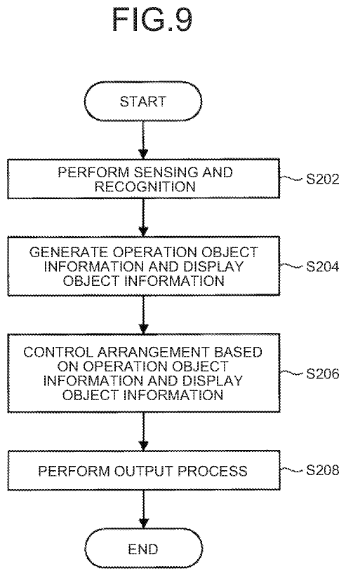

The configuration example of the information processing apparatus 1-2 according to the second embodiment has been described above. Next, operation of the information processing apparatus 1-2 according to the second embodiment will be described with reference to FIG. 9. FIG. 9 is a flowchart illustrating an example of the operation performed by the information processing apparatus 1-2 according to the second embodiment.

First, the sensor unit 11 performs sensing, and the recognition unit 120 performs recognition on the user and recognition on the surrounding conditions by using various kinds of sensor information obtained by the sensing (S202). Subsequently, the object information generation unit 121 generates the operation object information and the display object information (S204).

Further, the arrangement control unit 123 controls arrangement of a virtual object on the basis of the operation object information and the display object information generated at Step S204 (S206). Specific examples of an arrangement control process at Step S206 will be described later with reference to FIG. 10 to FIG. 17. Meanwhile, the arrangement control unit 123 may repeat the process at Step S206 in accordance with the number of types of the operation object information and the display object information generated at Step S204.

Finally, the output control unit 128 causes the display unit 13 to display (output) the virtual object in accordance with the arrangement control on the virtual object performed by the arrangement control unit 123 (S208). Meanwhile, the processes at Step S202 to S208 as described above may be repeated sequentially.

<2-4. Examples of Arrangement Control>

Examples of the arrangement control according to the second embodiment will be described in detail below with reference to FIG. 10 to FIG. 17. In FIG. 10 to FIG. 17, the user U is wearing the information processing apparatus 1-2 that is a glasses-type HMD as illustrated in FIG. 1. Further, virtual objects V21 to V23 that are displayed on the display unit 13, which is a transmissive type and located in front of the eyes of the User U, in the information processing apparatus 1 are viewed as if the virtual objects V21 to V23 are arranged on the display object.

(First Arrangement Control Example)

FIG. 10 is an explanatory diagram for explaining a first arrangement control example. In the example illustrated in FIG. 10, similarly to the example illustrated in FIG. 7, the left hand HL of the user is used as the display object, and the virtual objects V21 to V23 are displayed on the display unit 13 as if the virtual objects V21 to V23 are arranged on the left hand HL (in such a manner that the virtual objects V21 to V23 are viewed by the user). Further, in the example illustrated in FIG. 10, similarly to the example illustrated in FIG. 7, the user performs the touch operation by using the finger FR of the right hand HR as the operation object.

Here, the object information generation unit 121 predicts a future movement trajectory T1 of the finger FR on the basis of a past movement history D1 of the finger FR, and generates the operation object information that includes the movement trajectory T1 as the movement information. Then, as illustrated in FIG. 10, the arrangement control unit 123 controls arrangement of the virtual objects V21 to V23 such that the finger FR does not touch a plurality of the virtual objects when the finger FR moves in accordance with the movement trajectory T1, on the basis of the movement trajectory T1 (movement information). With this configuration, it is possible to prevent operation input that is not intended by the user.

(Second Arrangement Control Example)

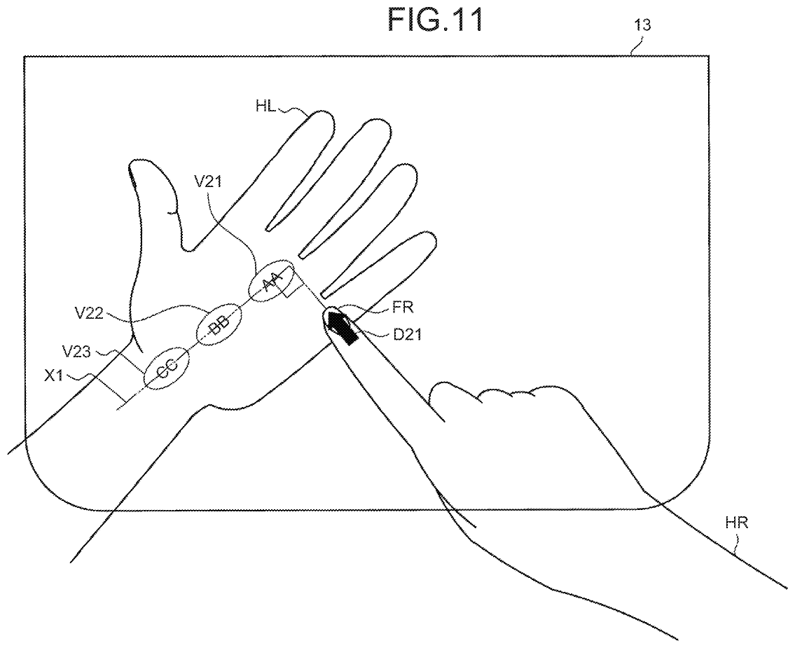

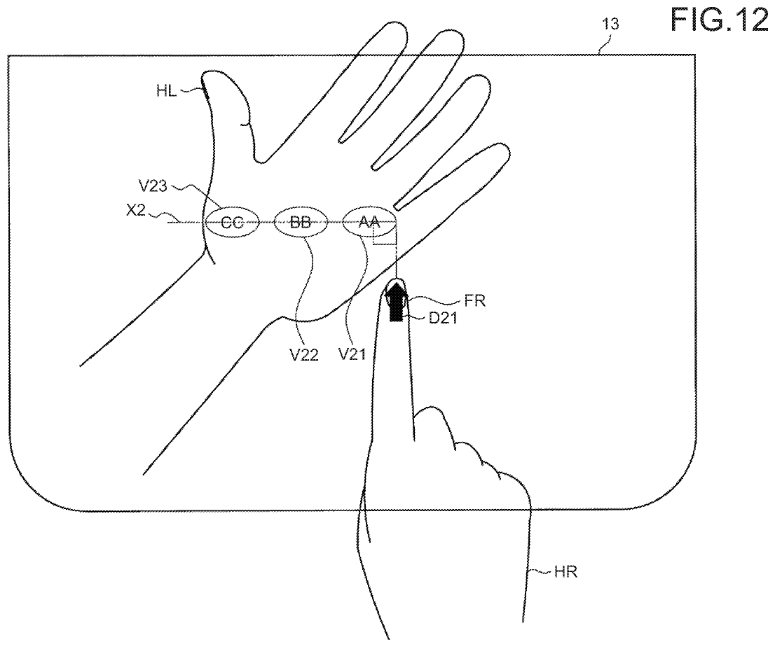

FIG. 11 and FIG. 12 are explanatory diagrams for explaining a second arrangement control example. In the example illustrated in FIG. 11 and FIG. 12, the left hand HL of the user is used as the display object, and the virtual objects V21 to V23 are displayed in the display unit 13 as if the virtual objects V21 to V23 are arranged on the left hand HL (in such a manner that the virtual objects V21 to V23 are viewed by the user). Further, in the example illustrated in FIG. 11 and FIG. 12, the user performs the touch operation by using the finger FR of the right hand HR as the operation object.

In the example illustrated in FIG. 11 and FIG. 12, the object information generation unit 121 generates the operation object information that includes a past movement history D21 and a movement history D22 of the finger FR as the movement information. Here, if, for example, virtual objects are arranged along each of directions of the movement histories, similarly to the example as described above with reference to FIG. 7, operation input that is not intended by the user is likely to be performed.

Therefore, as illustrated in FIG. 11, the arrangement control unit 123 causes the virtual objects V21 to V23 to be arranged along an axis X1 that is perpendicular to the direction of the movement history D21 on the basis of the movement history D21 (movement information). Further, as illustrated in FIG. 12, the arrangement control unit 123 causes the virtual objects V21 to V23 to be arranged along an axis X2 that is perpendicular to the movement history D22 on the basis of the movement history D22 (movement information). With this configuration, for example, it is possible to prevent operation input that is not intended by the user.

Meanwhile, if a difference between current arrangement of the virtual objects V21 to V23 and arrangement based on the movement history is small, the arrangement control unit 123 may refrain from making a change of the arrangement. With this configuration, it is possible to reduce the possibility that the user may feel discomfort due to a change of the arrangement.

(Third Arrangement Control Example)

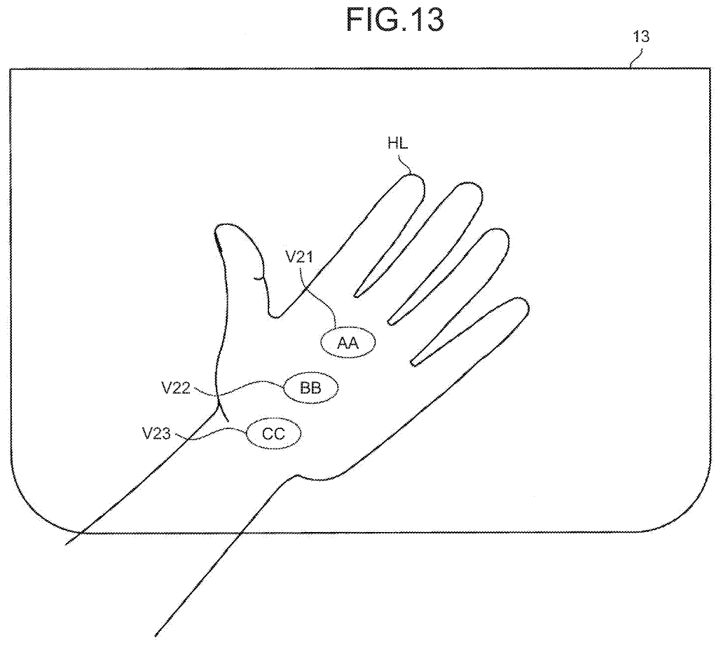

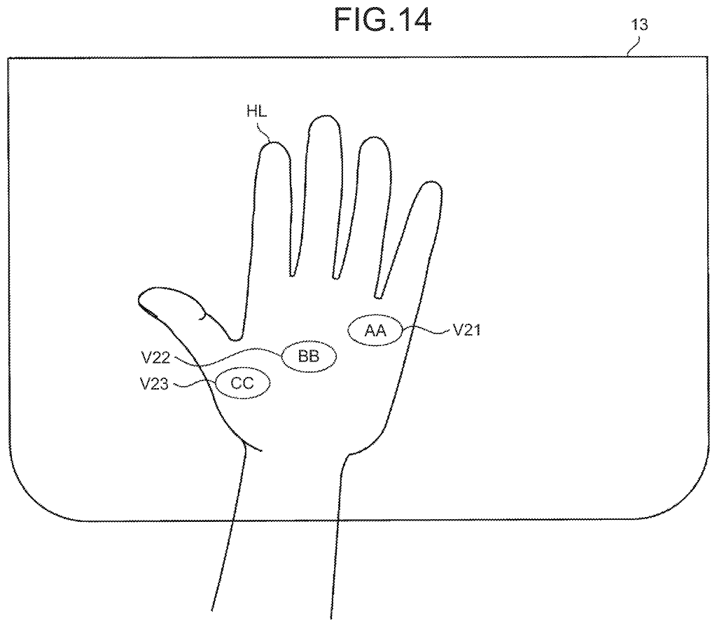

FIG. 13 and FIG. 14 are explanatory diagrams for explaining a third arrangement control example. In the example illustrated in FIG. 13 and FIG. 14, the left hand HL of the user is used as the display object, and the virtual objects V21 to V23 are displayed on the display unit 13 as if the virtual objects V21 to V23 are arranged on the left hand HL (in such a manner that the virtual objects V21 to V23 are viewed by the user).

In the example illustrated in FIG. 13 and FIG. 14, the object information generation unit 121 generates the display object information including information on an angle of the left hand HL serving as the display object. Then, the arrangement control unit 123 arranges the virtual objects V21 to V23 at easily-viewable positions in accordance with the angle of the left hand HL. With this configuration, the user is able to precisely recognize the virtual objects and perform operation input.

(Fourth Arrangement Control Example)

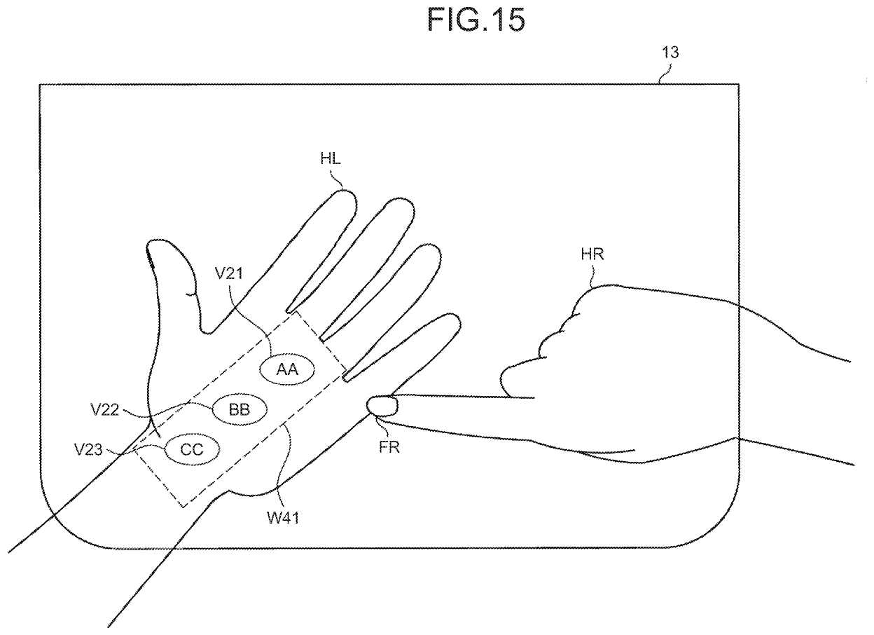

FIG. 15 to FIG. 17 are explanatory diagrams for explaining a fourth arrangement control example. In the example illustrated in FIG. 15, the left hand HL of the user is used as the display object, and the virtual objects V21 to V23 are displayed on the display unit 13 as if the virtual objects V21 to V23 are arranged on the left hand HL (in such a manner that the virtual objects V21 to V23 are viewed by the user). Further, in the example illustrated in FIG. 15, the user performs the touch operation by using the finger FR of the right hand HR as the operation object.

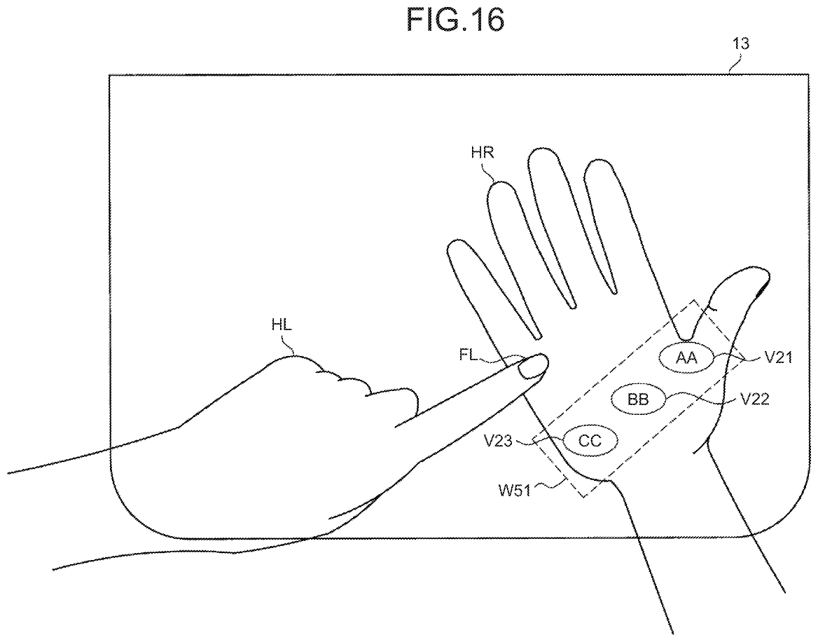

In contrast, in the example illustrated in FIG. 16, the right hand HR of the user is used as the display object, and the virtual objects V21 to V23 are displayed on the display unit 13 as if the virtual objects V21 to V23 are arranged on the right hand HR (in such a manner that the virtual objects V21 to V23 are viewed by the user). Further, in the example illustrated in FIG. 16, the user performs the touch operation by using a finger FL of the left hand HL as the operation object. Here, in FIG. 16, the virtual objects V21 to V23 are arranged in accordance with an arrangement range W51 that is similar to an arrangement range W41 (for example, a default setting) illustrated in FIG. 15. As a result, the virtual objects V21 to V23 are arranged in such a manner that operation input using the finger FL of the left hand HL is difficult, so that operation input that is not intended by the user may be performed.

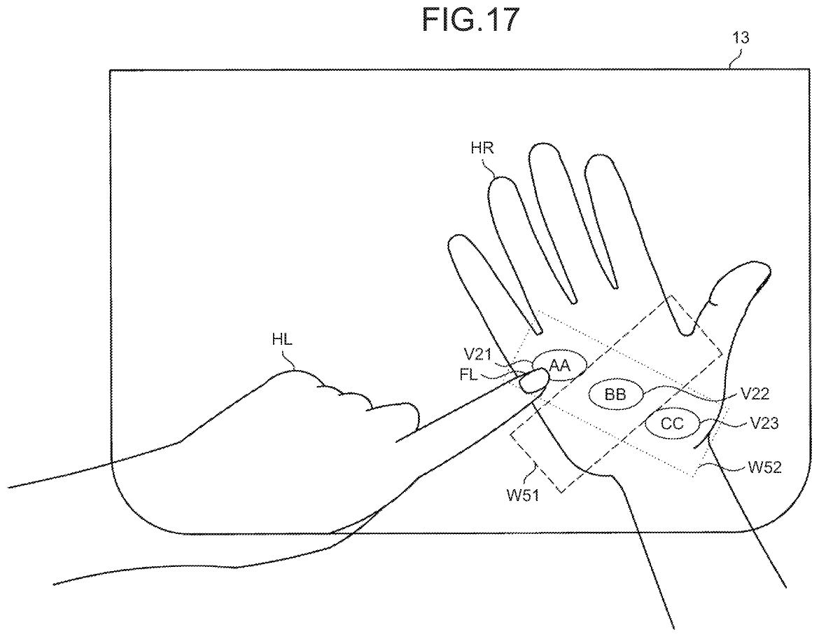

Therefore, the object information generation unit 121 may generate the display object information including information on a type of the display object (the left hand or the right hand), and the arrangement control unit 123 may control the arrangement of the virtual objects on the basis of the type of the display object. In the example illustrated in FIG. 17, an angle of the arrangement range W52 is changed based on the fact that the right hand HR is used as the display object, and the virtual objects V21 to V23 are arranged in accordance with the arrangement range W52. With this configuration, for example, it is possible to prevent operation input that is not intended by the user.

<2-5. Modifications>

The second embodiment of the present disclosure has been described above. In the following, some modifications of the second embodiment will be described. Meanwhile, the modifications described below may independently be applied to the second embodiment, or may be applied to the second embodiment in a combined manner. Further, each of the modifications may be applied in place of the configurations described in the second embodiment, or may be applied in addition to the configurations described in the second embodiment.

(Modification 2-1)

As illustrated in FIG. 8, the control unit 12-2 according to the second embodiment does not have the function as the input method determination unit, and, in the second embodiment, the touch operation is fixedly determined as the operation input method, for example. However, the control unit 12-2 may have the function as the input method determination unit 124, similarly to the control unit 12 according to the first embodiment.

(Modification 2-2)

Furthermore, the arrangement control unit 123 may control the arrangement of the virtual objects further based on a distance between the operation object and the display object. For example, the arrangement control unit 123 may change intensity of a change of the arrangement that is based on the operation object information or the display object information, on the basis of the distance between the operation object and the display object. If the distance between the operation object and the display object is small, by reducing the intensity of the change of the arrangement based on the operation object information or the display object information, it may be possible to prevent a large change of the arrangement just before the touch operation is performed, for example.

(Modification 2-3)

Moreover, the arrangement control unit 123 may control the arrangement of the virtual objects further based on a distance between the sensor unit 11 and the display object. For example, if the distance between the sensor unit 11 and the display object is smaller than a predetermined distance, the arrangement control unit 123 may cause the virtual objects to be arranged in a place outside of the display object.

(Modification 2-4)

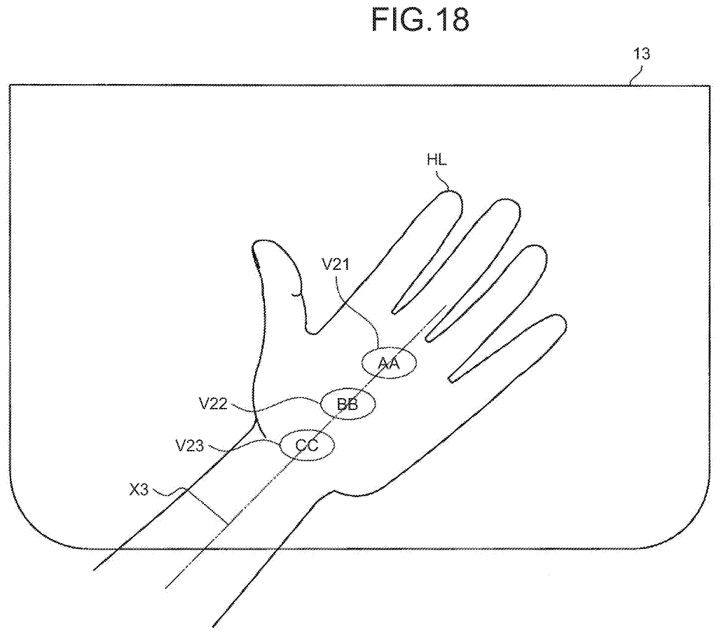

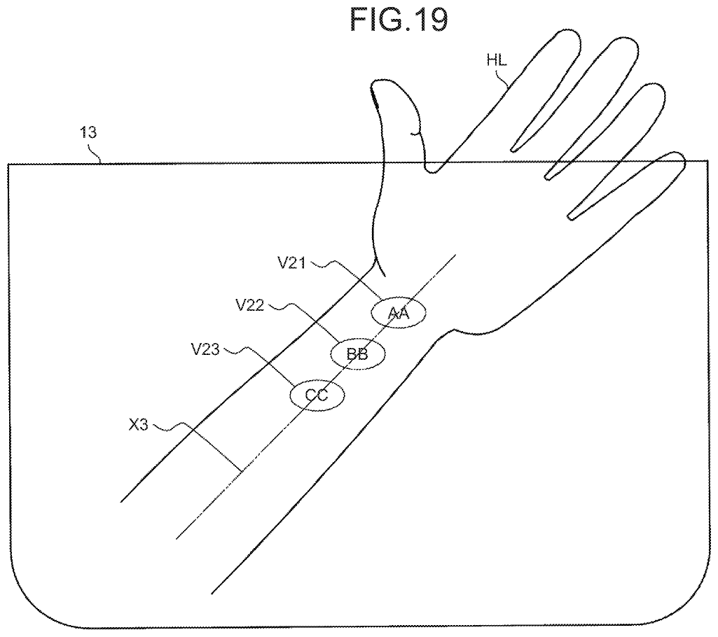

Furthermore, the arrangement control unit 123 may control the arrangement of the virtual objects such that the virtual objects are displayed in a display region of the display unit 13. FIG. 18 and FIG. 19 are explanatory diagrams for explaining the present modification. In the example illustrated in FIG. 18, the left hand HL of the user is used as the display object, and the virtual objects V21 to V23 are displayed on the display unit 13 as if the virtual objects V21 to V23 are arranged on the left hand HL (in such a manner that the virtual objects V21 to V23 are viewed by the user).

Here, when the left hand HL is moved from the state illustrated in FIG. 18 to the state illustrated in FIG. 19, and if the virtual objects V21 to V23 are moved in accordance with the movement of the left hand HL, the virtual objects are not displayed in the display region of the display unit 13. Therefore, the arrangement control unit 123 may cause the virtual objects V21 to V23 to be arranged at positions along a movable axis X3 (for example, an axis of the left hand HL) such that the virtual objects V21 to V23 can be displayed in the display region. With this configuration, the user can be prevented from losing sight of the virtual objects.

(Modification 2-5)

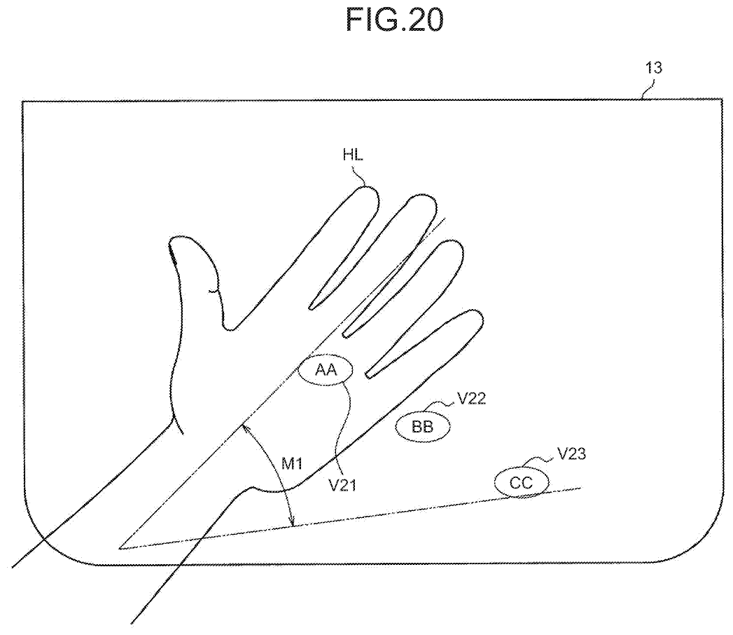

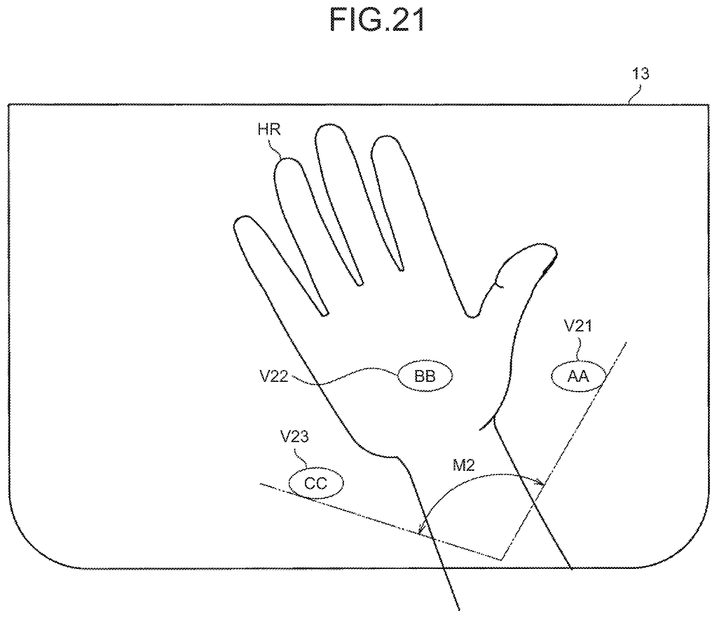

Moreover, the operation object and the display object may be the same real object. FIG. 20 and FIG. 21 are explanatory diagrams for explaining the present modification. In the present modification, for example, virtual objects are arranged on the basis of a real object in a state in which the real object is recognized for the first time. Subsequently, even if the real object is moved, the virtual objects are fixed in the real space. Thereafter, the user performs operation input by using the real object as the operation object. For example, if the real object is a hand, it may be possible to perform operation input for selection by a gesture of grasping a virtual object.

Here, the arrangement control unit 123 according to the present modification may control arrangement of virtual objects on the basis of a movable range of the real object. For example, the arrangement control unit 123 may arrange all of the virtual objects in the movable range of the real object.

Meanwhile, if the real object used as the operation object and the display object is a hand, it is possible to identify the movable range on the basis of a type of the real object (the left hand or the right hand), current positions and postures of the hands and the arms, or the like.

In the example illustrated in FIG. 20, the left hand HL of the user is used as the operation object and the display object, and, for example, the arrangement control unit 123 arranges the virtual objects V21 to V23 on the basis of a movable range M1 of the left hand HL in the state in which the left hand HL is recognized for the first time.

Further, in the example illustrated in FIG. 21, the right hand HR of the user is used as the operation object and the display object, and, for example, the arrangement control unit 123 arranges the virtual objects V21 to V23 on the basis of a movable range M2 of the right hand HR in the state in which the right hand HR is recognized for the first time.

With this configuration, even if the operation object and the display object are the same real object, it is possible to improve usability.

<2-6. Effects>

Thus, the second embodiment of the present disclosure has been described above. According to the second embodiment, it is possible to prevent operation input that is not intended by the user by controlling arrangement of virtual objects on the basis of information on recognition of the operation object or recognition of the display object.

### 3. Hardware Configuration

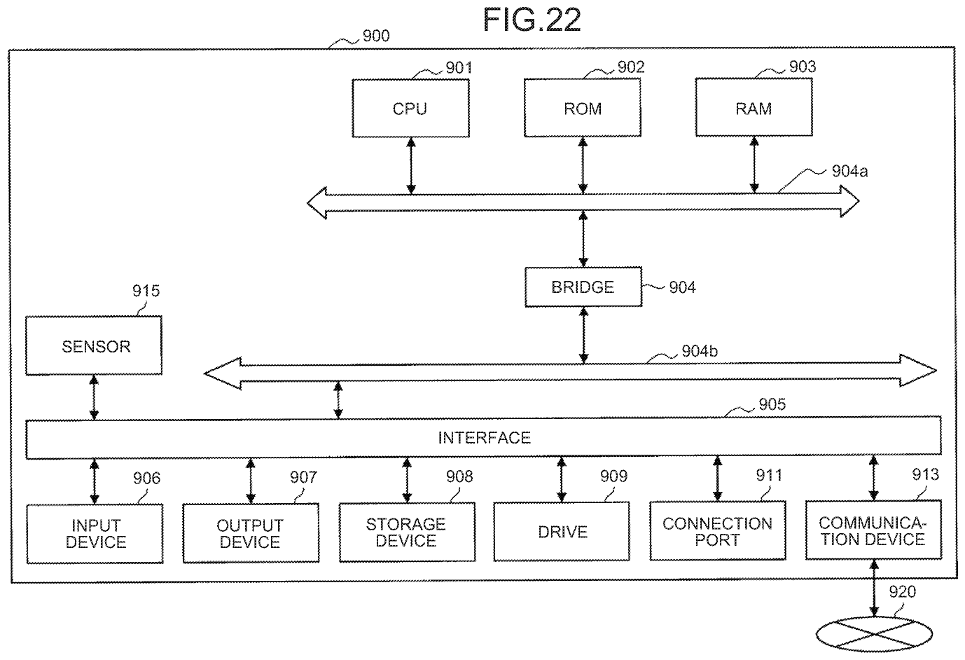

The embodiments of the present disclosure have been described above. Finally, with reference to FIG. 22, a hardware configuration of the information processing apparatus according to the embodiments will be described. FIG. 22 is a block diagram illustrating a hardware configuration example of the information processing apparatus according to the embodiments. Meanwhile, an information processing apparatus 900 illustrated in FIG. 22 can implement, for example, the information processing apparatus 1 and the information processing apparatus 1-2. Information processing performed by the information processing apparatus 1 and the information processing apparatus 1-2 according to the embodiments is realized by cooperation of software and hardware as described below.

As illustrated in FIG. 22, the information processing apparatus 900 includes a central processing unit (CPU) 901, a read only memory (ROM) 902, a random access memory (RAM) 903, and a host bus 904a . Further, the information processing apparatus 900 includes a bridge 904, an external bus 904b , an interface 905, an input device 906, an output device 907, a storage device 908, a drive 909, a connection port 911, a communication device 913, and a sensor 915. The information processing apparatus 900 may include a processing circuit, such as a DSP or an ASIC, in place of or in addition to the CPU 901.

The CPU 901 functions as an arithmetic processing device and a control device, and controls entire operation in the information processing apparatus 900 in accordance with various programs. Further, the CPU 901 may be a microprocessor. The ROM 902 stores therein programs, calculation parameters, and the like used by the CPU 901. The RAM 903 temporarily stores therein programs used during execution by the CPU 901, parameters that are appropriately changed during the execution, and the like. The CPU 901 may construct, for example, the control unit 12 and the control unit 12-2.

The CPU 901, the ROM 902, and the RAM 903 are connected to one another via the host bus 904a including a CPU bus or the like. The host bus 904a is connected to the external bus 904b , such as a peripheral component interconnect/interface (PCI) bus, via the bridge 904. Meanwhile, the host bus 904a , the bridge 904, and the external bus 904b need not always be constructed separately, but all of the functions may be implemented in a single bus.

The input device 906 is realized by a device, such as a mouse, a keyboard, a touch panel, a button, a microphone, a switch, or a lever, by which information is input by a user. Further, the input device 906 may be, for example, a remote control device using infrared or other radio waves, or may be an external connected device, such as a mobile phone or a PDA, compatible with operation of the information processing apparatus 900. Furthermore, the input device 906 may include, for example, an input control circuit that generates an input signal on the basis of information that is input by the user using the above-described input means, and outputs the input signal to the CPU 901. A user of the information processing apparatus 900 is able to input various kinds of data or give an instruction on processing operation to the information processing apparatus 900 by operating the input device 906.

The output device 907 is constructed by a device capable of visually or aurally notifying the user of the acquired information. Examples of the above-described device include a display device, such as a CRT display device, a liquid crystal display device, a plasma display device, an EL display device, and a lamp, an audio output device, such as a speaker and a headphone, and a printer device. The output device 907 outputs, for example, results that are obtained through various kinds of processing performed by the information processing apparatus 900. Specifically, the display device visually displays results obtained through various kinds of processing performed by the information processing apparatus 900 in various formats, such as text, an image, a table, or a graph. In contrast, the audio output device converts an audio signal formed of reproduced voice data, acoustic data, or the like into an analog signal, and aurally outputs the analog signal. The output device 907 may construct, for example, the display unit 13 and the speaker 14.

The storage device 908 is a device for storing data and is constructed as one example of a storage unit of the information processing apparatus 900. The storage device 908 is realized by, for example, a magnetic storage device, such as an HDD, a semiconductor storage device, an optical storage device, a magneto optical storage device, or the like. The storage device 908 may include a storage medium, a recording device for recording data in a storage medium, a reading device for reading data from a storage medium, and a deleting device for deleting data recorded in a storage medium, or the like. The storage device 908 stores therein programs and various kinds of data executed by the CPU 901, various kinds of data acquired from external devices, or the like. The above-described storage device 908 may construct, for example, the storage unit 17.

The drive 909 is a reader/writer for a storage medium, and is incorporated in or externally attached to the information processing apparatus 900. The drive 909 reads information recorded in an attached removable storage medium, such as a magnetic disk, an optical disk, a magneto optical disk, or a semiconductor memory, and outputs the information to the RAM 903. Further, the drive 909 is able to write information in the removable storage medium.

The connection port 911 is an interface connected to an external device, and serves as a connection port for the external device to which data can be transmitted via a universal serial bus (USB), for example.

The communication device 913 is a communication interface constructed by a communication device for connecting to a network 920, for example. The communication device 913 is, for example, a communication card or the like used for a wireless local area network (LAN), long term evolution (LTE), Bluetooth (registered trademark), or a wireless USB (WUSB). Further, the communication device 913 may be a router for optical communication, a router for asymmetric digital subscriber line (ADSL), a modem for various kinds of communication, or the like. The communication device 913 is able to transmit and receive a signal or the like in accordance with a predetermined protocol, such as TCP/IP, to and from the Internet or other communication devices, for example. The communication device 913 may construct, for example, the communication unit 15.

The sensor 915 is, for example, various sensors, such as an acceleration sensor, a gyro sensor, a geomagnetic sensor, an optical sensor, an audio sensor, a ranging sensor, or a force sensor. The sensor 915 acquires information on a state of the information processing apparatus 900, such as a posture or a moving speed of the information processing apparatus 900, and information on surrounding environments of the information processing apparatus 900, such as brightness or noise around the information processing apparatus 900. Further, the sensor 915 may include a GPS sensor that receives a GPS signal and measures a latitude, a longitude, and an altitude of a device. The sensor 915 may construct, for example, the sensor unit 11.

Meanwhile, the network 920 is a wired or wireless transmission path for information that is transmitted from a device connected to the network 920. For example, the network 920 may include a public network, such as the Internet, a telephone line network, or a satellite communication network, or various local area networks (LANs) and wide area networks (WANs) including Ethernet (registered trademark). Further, the network 920 may include a dedicated network, such as an internet protocol-virtual private network (IP-VPN).

Thus, one example of the hardware configuration capable of realizing the functions of the information processing apparatus 900 according to the embodiments has been described above. The above-described structural elements may be implemented by using general-purpose members, or may be implemented by hardware specific to a function of each of the structural elements. Therefore, it is possible to appropriately change a hardware configuration to be used in accordance with a technology level at the time the embodiments are embodied.

Meanwhile, it is possible to generate a computer program for realizing each of the functions of the information processing apparatus 900 according to the embodiments as described above, and implements the program in a PC or the like. Further, it is possible to provide a computer readable recording medium in which the above-described computer program is stored. Examples of the recording medium include a magnetic disk, an optical disk, a magneto optical disk, and a flash memory. Furthermore, the above-described computer program may be distributed via a network without using a recording medium, for example.

### 4. Conclusion

As described above, according to the embodiments of the present disclosure, it is possible to improve usability.

While the preferred embodiments of the present disclosure have been described in detail above with reference to the accompanying drawings, the technical scope of the present disclosure is not limited to the examples as described above. It is obvious that a person skilled in the technical field of the present disclosure may conceive various alternations and modifications within the scope of the technical idea of the appended claims, and it should be understood that they will naturally come under the technical scope of the present disclosure.

For example, in the embodiments described above, the example has been mainly described in which the display unit 13 is a transmissive type, but the technology is not limited to this example. For example, even if the display unit 13 is a non-transmissive type, it is possible to achieve the same effects as described above by displaying, in a superimposed manner, virtual objects on an image of a real space captured by the camera 110. Further, even if the display unit 13 is a projector, it is possible to achieve the same effects as described above by projecting virtual objects in a real space.

Furthermore, each of Steps in the embodiments described above need not always be processed in chronological order as illustrated in the flowchart. For example, each of Steps in the processes of the embodiments described above may be executed in different order from the order illustrated in the flowchart, or may be performed in a parallel manner.

Moreover, the effects described in this specification are merely illustrative or exemplified effects, and are not limitative. That is, with or in the place of the above effects, the technology according to the present disclosure may achieve other effects that are clear to those skilled in the art from the description of this specification.

The following configurations are also within the technical scope of the present disclosure.
(1)

An information processing apparatus comprising:

an input method determination unit configured to determine an operation input method related to a virtual object that is arranged in a real space, on the basis of arrangement information on the virtual object.
(2)

The information processing apparatus according to (1), wherein the input method determination unit determines the operation input method on the basis of one of a recognition result on a user and a recognition result on surrounding conditions.
(3)

The information processing apparatus according to (2), wherein the input method determination unit determines whether the user is able to touch the virtual object on the basis of the recognition result on the user, and determines the operation input method on the basis of the previous determination.
(4)

The information processing apparatus according to (3), wherein if the user is able to touch the virtual object, the input method determination unit determines touch operation as the operation input method.
(5)

The information processing apparatus according to any one of (2) to (4), wherein the input method determination unit determines whether a real object present in a real space and the virtual object are in contact with each other on the basis of the recognition result on the surrounding conditions, and determines the operation input method on the basis of the previous determination.
(6)

The information processing apparatus according to (5), wherein if the real object and the virtual object are in contact with each other, the input method determination unit determines pointing operation as the operation input method.
(7)

The information processing apparatus according to any one of (1) to (6), further comprising:

an operation input receiving unit configured to receive operation input that is performed on the virtual object by a user, by using information corresponding to the operation input method determined by the input method determination unit.
(8)

The information processing apparatus according to any one of (1) to (7), further comprising:

an arrangement control unit configured to control arrangement of the virtual object.
(9)

The information processing apparatus according to (8), wherein the arrangement control unit controls arrangement of the virtual object on the basis of the operation input method determined by the operation input method determination unit.
(10)

The information processing apparatus according to (8) or (9), wherein the arrangement control unit controls arrangement of the virtual object on the basis of operation input performed by a user.
(11)

The information processing apparatus according to any one of (8) to (10), wherein the arrangement control unit controls arrangement of the virtual object on the basis of a distance between the virtual object and a user.
(12)

The information processing apparatus according to any one of (8) to (11), wherein the arrangement control unit controls arrangement of the virtual object on the basis of one of operation object information on an operation object that is used for operation input performed by a user and display object information on a display object that is used to display the virtual object.
(13)

The information processing apparatus according to (12), wherein

the operation object information includes movement information on movement of the operation object, and

the arrangement control unit controls arrangement of the virtual object on the basis of the movement information.
(14)

The information processing apparatus according to (12) or (13), wherein

the display object information includes at least one of information on a type of the display object, information on an angle of the display object, and information on a state of the display object, and

the arrangement control unit controls arrangement of the virtual object on the basis of the display object information.
(15)

The information processing apparatus according to any one of (12) to (14), wherein the arrangement control unit controls arrangement of the virtual object further based on a distance between the operation object and the display object.
(16)

The information processing apparatus according to any one of (12) to (15), wherein the arrangement control unit controls arrangement of the virtual object such that the virtual object is displayed in a display region of a display unit that displays the virtual object.
(17)

The information processing apparatus according to (12), wherein

the operation object and the display object are a same real object, and

the arrangement control unit controls arrangement of the virtual object on the basis of a movable range of the real object.
(18)

The information processing apparatus according to any one of (1) to (17), further comprising:

an output control unit configured to cause a transmissive type display unit to display the virtual object.
(19)

An information processing method comprising:

determining an operation input method related to a virtual object that is arranged in a real space, on the basis of arrangement information on the virtual object.
(20)

A program that causes a computer to realize a function to execute:

determining an operation input method related to a virtual object that is arranged in a real space, on the basis of arrangement information on the virtual object.

### REFERENCE SIGNS LIST

1, 1-2 information processing apparatus

11 sensor unit

12, 12-2 control unit

13 display unit

14 speaker

15 communication unit

16 operation input unit

17 storage unit

110 out-camera

111 in-camera

112 mic

113 gyro sensor

114 acceleration sensor

115 orientation sensor

116 location positioning unit

117 biological sensor

120 recognition unit

121 object information generation unit

122, 123 arrangement control unit

124 input method determination unit

126 operation input receiving unit

128 output control unit

1. An information processing apparatus comprising:
an input method determination unit configured to determine an operation input method related to a virtual object that is arranged in a real space, on the basis of arrangement information on the virtual object.

2. The information processing apparatus according to claim 1, wherein the input method determination unit determines the operation input method on the basis of one of a recognition result on a user and a recognition result on surrounding conditions.

3. The information processing apparatus according to claim 2, wherein the input method determination unit determines whether the user is able to touch the virtual object on the basis of the recognition result on the user, and determines the operation input method on the basis of the previous determination.

4. The information processing apparatus according to claim 3, wherein if the user is able to touch the virtual object, the input method determination unit determines touch operation as the operation input method.

5. The information processing apparatus according to claim 2, wherein the input method determination unit determines whether a real object present in a real space and the virtual object are in contact with each other on the basis of the recognition result on the surrounding conditions, and determines the operation input method on the basis of the previous determination.

6. The information processing apparatus according to claim 5, wherein if the real object and the virtual object are in contact with each other, the input method determination unit determines pointing operation as the operation input method.

7. The information processing apparatus according to claim 1, further comprising:
an operation input receiving unit configured to receive operation input that is performed on the virtual object by a user, by using information corresponding to the operation input method determined by the input method determination unit.

8. The information processing apparatus according to claim 1, further comprising:
an arrangement control unit configured to control arrangement of the virtual object.

9. The information processing apparatus according to claim 8, wherein the arrangement control unit controls arrangement of the virtual object on the basis of the operation input method determined by the operation input method determination unit.

10. The information processing apparatus according to claim 8, wherein the arrangement control unit controls arrangement of the virtual object on the basis of operation input performed by a user.

11. The information processing apparatus according to claim 8, wherein the arrangement control unit controls arrangement of the virtual object on the basis of a distance between the virtual object and a user.

12. The information processing apparatus according to claim 8, wherein the arrangement control unit controls arrangement of the virtual object on the basis of one of operation object information on an operation object that is used for operation input performed by a user and display object information on a display object that is used to display the virtual object.

13. The information processing apparatus according to claim 12, wherein
the operation object information includes movement information on movement of the operation object, and
the arrangement control unit controls arrangement of the virtual object on the basis of the movement information.

14. The information processing apparatus according to claim 12, wherein
the display object information includes at least one of information on a type of the display object, information on an angle of the display object, and information on a state of the display object, and
the arrangement control unit controls arrangement of the virtual object on the basis of the display object information.

15. The information processing apparatus according to claim 12, wherein the arrangement control unit controls arrangement of the virtual object further based on a distance between the operation object and the display object.

16. The information processing apparatus according to claim 12, wherein the arrangement control unit controls arrangement of the virtual object such that the virtual object is displayed in a display region of a display unit that displays the virtual object.

17. The information processing apparatus according to claim 12, wherein
the operation object and the display object are a same real object, and
the arrangement control unit controls arrangement of the virtual object on the basis of a movable range of the real object.

18. The information processing apparatus according to claim 1, further comprising:
an output control unit configured to cause a transmissive type display unit to display the virtual object.

19. An information processing method comprising:
determining an operation input method related to a virtual object that is arranged in a real space, on the basis of arrangement information on the virtual object.

20. A program that causes a computer to realize a function to execute:
determining an operation input method related to a virtual object that is arranged in a real space, on the basis of arrangement information on the virtual object.
